(19) United States
(12) Patent Application Publication
(10) Pub. No.: US 2025/0076835 A1
(43) Pub. Date: Mar. 6, 2025

(54) VERIFICATION SYSTEM, AND VERIFICATION METHOD

(71) Applicant: TDK CORPORATION, Tokyo (JP)

(72) Inventors: Ruriko SATO, Tokyo (JP); Shinji ATSUZAWA, Tokyo (JP); Osamu OHHATA, Tokyo (JP); Shingo OZEKI, Tokyo (JP); Masashi MATSUMOTO, Tokyo (JP)

(73) Assignee: TDK CORPORATION, Tokyo (JP)

(21) Appl. No.: 18/727,132

(22) PCT Filed: Jan. 18, 2023
(86) PCT No.: PCT/JP2023/001400

§ 371 Date: Jul. 8, 2024

(30) Foreign Application Priority Data
Jan. 20, 2022 (JP) 2022-007141

(51) Int. Cl. G05B 19/05

(52) U.S. Cl. CPC G05B 19/054; G05B 19/058

(57) ABSTRACT

An environment in which a control device for controlling a controlled object can easily be verified. This verification system includes: a simulator for simulating an operating state of the controlled object; and a dummy device for generating a second signal relating to the controlled object instead of the simulator or the controlled object, in accordance with a first signal provided from a control device capable of controlling the controlled object, and providing the generated second signal to the control device or the simulator. The simulator generates a third signal indicating the simulated operating state of the controlled object on the basis of the second signal provided from the dummy device.

### TECHNICAL FIELD

The present disclosure relates to a technology verifying a movement of a control device controlling an object to be controlled such as a manufacturing device, etc.

### BACKGROUND

If operated condition of machines, apparatuses, devices, etc., can be verified in a virtual environment formed in a virtual space, that is, without using actual devices, it is effective from the point of work efficiency, etc. In recent years, a technology has been proposed which builds a digital twin environment emulating an actual space in the virtual space for such verification. In order to carry out the verification of the operated condition of the devices in the virtual space, a simulator simulating the movement of the device, an emulator emulating the movement of the device are used.

In recent years, a system and a modeling tool added with a simulation system and a verification system carrying out the verification of the movement of the device have been proposed. As one example of such systems, CAD (Computer-Aided Design) equipped with a simulation system is provided. The simulation system of CAD, for example, uses a design data of the device and simulates the movement of the device designed on a computer

Regarding a device which operates while being controlled by control devices (including a so-called CPU (Central Processing Unit), a micro-processor, a computer, etc.,), a verification of a control program (software) can be carried out easily by using such virtual environment. In regards with the device of which a movement simulation can be done by CAD, by executing a control program of the control device via I/F (Inter Face) of CAD, a movement of the actual machine can be simulated in CAD system (for example, a computer which executes CAD application), thus, enables a verification of the control program.

As one of such type of system, for example, Patent Document 1 discloses a device designing manufacturing support system including a device simulator, and the system can verify the movement of software, etc., before an actual machine is assembled. Also, Patent Document 2 discloses a system which simulates a sequence control and a motion control of the object to be controlled, and the simulation result is displayed by a display object visualizing the object to be controlled; thereby, enables to easily verify the movement of the object.

However, for example, in the case of using CAD simulation for the movement verification of a large-scale and complicated system such as a production line involving large numbers of components, machines, apparatus, and devices, it is difficult to prepare data for the simulation of all of devices. Also, in the case that the control device controlling the actual machine of the production line and I/F of the CAD system are not compatible, control of the control device and the simulation system of the CAD system cannot be linked; thus, it is difficult to verify the movement in the virtual environment.

As such, in some cases it is not easy to execute the verification of the control movement of the control program or the verification of operated condition of the object to be controlled in the virtual environment.

Patent Document 1: WO2010/116547

Patent Document 2: JP Patent No. 6476594

### SUMMARY

The object of the present disclosure is to provide a technology easily achieving a verification of the operated condition of an object to be controlled.
A verification system according to an embodiment of the present disclosure, includes:

a simulator simulating an operated condition of an object to be controlled;

a dummy device, instead of the simulator or a control device, generating a second signal relating to the object based on a first signal to provide the generated second signal to the simulator or the control device, the first signal being provided from the control device capable of controlling the object;

wherein the simulator generates a third signal representing the operated condition of the object simulated based on the second signal provided from the dummy device.

Also, a verification method according to an embodiment of the present disclosure includes:

simulating an operated condition of an object to be controlled using a simulator;

generating a second signal relating to the object using a dummy device instead of a simulator or a control device based on a first signal to provide the generated second signal to the control device or to the simulator, the first signal being provided from the control device capable of controlling the object; and

generating a third signal, using the simulator, representing an operated condition of the object simulated based on the second signal provided from the dummy device.

### BRIEF DESCRIPTION DRAWINGS

FIG. 1 is a block diagram schematically showing an example of a production line.

FIG. 2 is a block diagram showing a configuration example of a control verification system of the production line included in an embodiment of technology according to the present disclosure.

FIG. 3 is a block diagram showing another configuration example of a control verification system of the production line included in one embodiment of technology according to the present disclosure.

FIG. 4 is a block diagram showing a conceptual configuration of PLC used as a dummy device PLC and a device PLC in the control verification system shown in FIG. 3.

FIG. 5 is a block diagram showing a configuration of PLC used as a dummy unit PLC and a device PLC in the control verification system shown in FIG. 3.

FIG. 6 is a diagram showing an example of connection between the device PLC and a manufacturing device in the production line shown in FIG. 3.

FIG. 7 is a diagram showing an example of communication between the device PLC and the manufacturing device in the production line shown in FIG. 3.

FIG. 8 is diagram explaining a configuration of a communication network in the control verification system shown in FIG. 3.

FIG. 9 is a diagram schematically explaining a system of the dummy device of the control verification system shown in FIG. 3.

FIG. 10 is a diagram showing an example of communication between the device PLC, a simulator 20, and a dummy device PLC 40 of the control verification system shown in FIG. 3.

### DETAILED DESCRIPTION

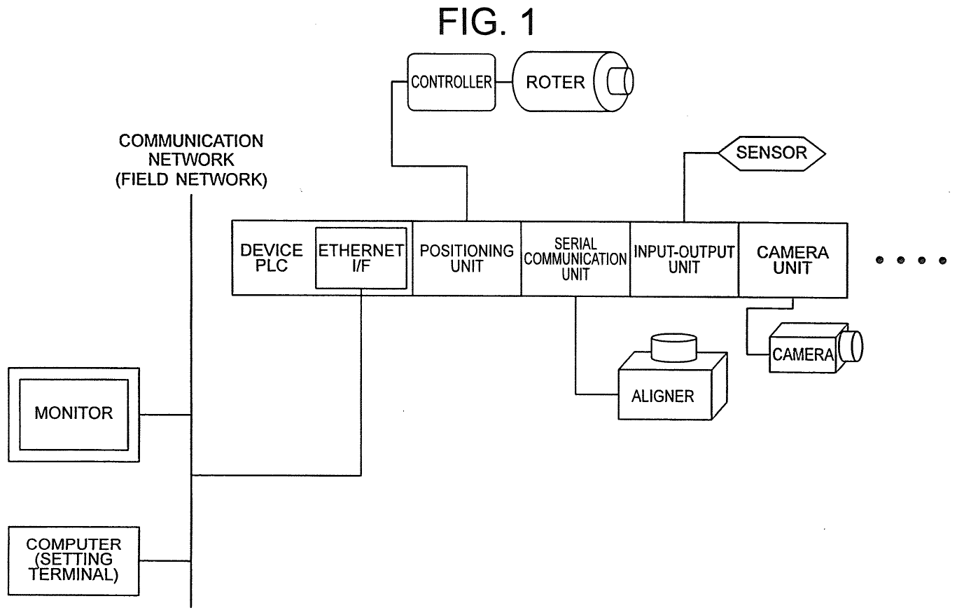

Before explaining the technologies according to the present embodiments, an example of a production line is described using FIG. 1. The exemplary production line shown in FIG. 1 is, for example, configured in a production site such as a factory, etc., by combining a physical device (such as various machines, apparatus, sensors, robots, communication devices) and a theoretical device (such as a theoretical device configured in a computer).

As shown in FIG. 1, the production line includes, for example, a device PLC (described later) capable of controlling a machine, various units (for example, positioning units, serial communication units, Ethernet communication units, input-output units, camera units) connected to the device PLC in a communicable manner, and includes various machines connected to the various units (for example, machine tools, motors, robots, sensors, cameras, image processing devices, and so on). For example, specific production steps can be achieved by controlling the movement of various units and various machines using a control program (for example, a ladder program) executed by the device PLC. A surveillance of the production line, a monitor capable of performing various settings, a computer, etc., may be connected to the production line via a communication network (for example, a below-described field network, etc.).

Regarding the following embodiments, a system capable of verifying the control movement of the control device in the production line shown in FIG. 1 as an example is explained as an example. Note that, FIG. 1 is an example simply for explanation, and the technology according to the present disclosure is not limited to the use of the production line shown in FIG. 1.

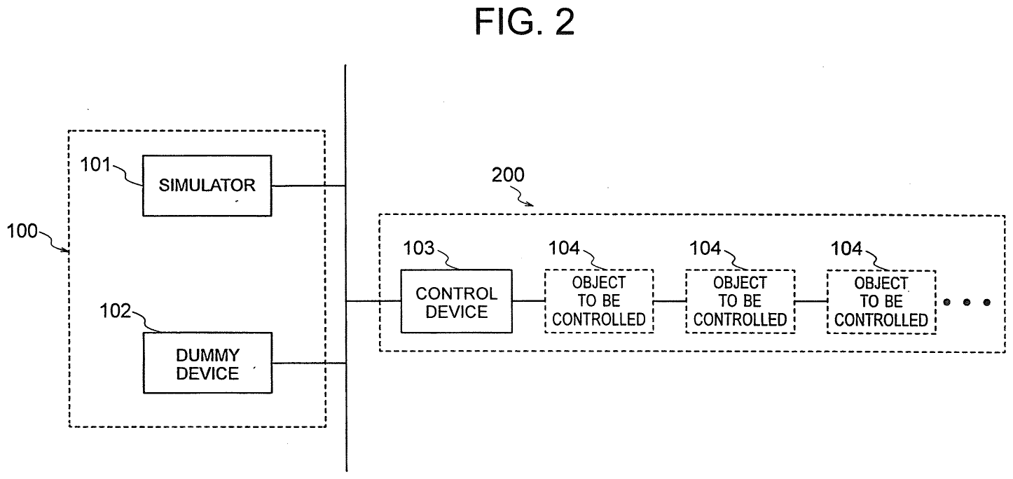

Next, an embodiment of the technology according to the present embodiment is described by referring to FIG. 2. FIG. 2 is a block diagram showing an example of a control verification system 100 which can verify a control movement of a control device 103 of a production line 200; in other words, the block diagram shows the control verification system 100 capable of verifying a control program set in a control device 103.

The production line 200 shown in FIG. 2 is a production line for producing a product. For example, the production line 200 may be a physical production line configured in real world. Note that, at least part of the production line 200 may be virtually configured, for example, using a computer or so.

The verification system 100 includes a simulator 101 and a dummy device 102.

The simulator 101 of the verification system 100 is configured to simulate the movement of an object to be controlled 104 (described later). For example, the simulator 101 may be configured by combining a widely used device such as a computer and software program. In such case, the software program may, for example, be a CAD application, or any other simulation tools. Note that, for example, the simulator 101 may be configured by combining a specialized hardware device (for example, a combination of a processor and a circuit element for a specific purpose). The simulator 101 virtually achieves at least part of the movement of the object 104; thereby, the simulator 101 instead of the object 104 can schematically execute the movement of the object 104. In some cases, at least part of the movement of the object 104 can be executed by the simulator 101.

A dummy device 102 receives a signal from a control device 103 capable of controlling the object 104, and based on the signals, the dummy device 102, instead of the simulator 101 or the object 104, provides at least part of the signals relating to the object to the control device 103 or the simulator 101. For example, the dummy device 102 may be configured by combining a widely used device such as a computer and software program; and it may be configured of a specialized hardware (for example, a combination of a processor for a specific purpose and a circuit element). For example, the dummy device 102 may be configured of a PLC of industrial use control device and a program executed by the PLC.

The control device 103 is a device which can control the object 104. The control device 103 can typically be configured of the industrially used PLC and the program executed by the PLC. Note that, for example, the control device 103 may be configured by combining a widely used device such as a computer and software program. In this case, for example, the software program may be an application program providing an environment (such as a development environment of PLC program) which can execute the program executed by the PLC in the computer.

The object 104 includes various devices, machines, etc., which are used for producing a product in the production line 200. For example, as shown in FIG. 1, the control device 104 may include various units (for example, positioning units, serial communication units, Ethernet communication units, input-output units, camera units), and various machines (for example, machine tools, rotors, robots, sensors, cameras, image processing devices, and others) which are connected to the various units. Note that, when verifying the movement of the control device 103 using the verification system 100, the object 104 does not necessarily have to be prepared. That is, the verification system 100 is configured to verify the movement of the control device 103 without the object 104 by using the simulator 101 and the dummy device 102.

In the verification system 100 configured as such, the simulator 101 receives signals from at least one of the dummy device 102 and the control device 103. Then, the simulator 101 virtually replicates at least an operated condition of the object 104 based on the received signals. Thereby, the verification system 100 can easily verify the control movement of the control device 103 even under the environment without the object 104.

In the case of verifying the movement of the control device 103, typically, the object 104 which is controlled by the control device is prepared, or a simulator or so which can act as the object 104 is prepared. However, in the case of verifying the movement of the control device 103 before configuring the actual production line, it is not necessarily easy to prepare the actual object 104. Also, the object 104 may include various devices as mentioned in above. Therefore, in some cases, it may be difficult to prepare simulators which can respectively act as various objects 104.

On the other hand, the dummy device 102 of the verification system 100 can provide signals relating to the object 104 instead of the simulator 101 or the object 104 based on the signals from the control device 103. For example, even in the environment where the object 104 is not prepared as an actual device, instead of the object 104, the dummy device 102 can provide the signals to the control device 103. Also, instead of the simulator 101, the dummy device 102 of the verification system 100 can provide the signals to the control device 103. In this case, even if the simulator 101 cannot replicate at least part of the movements of the object 104, the dummy device 102, instead of the simulator 101, can provide the signals to the control device 103. Due to such processing, the control device 103 can continue various processing as if the object 104 exists.

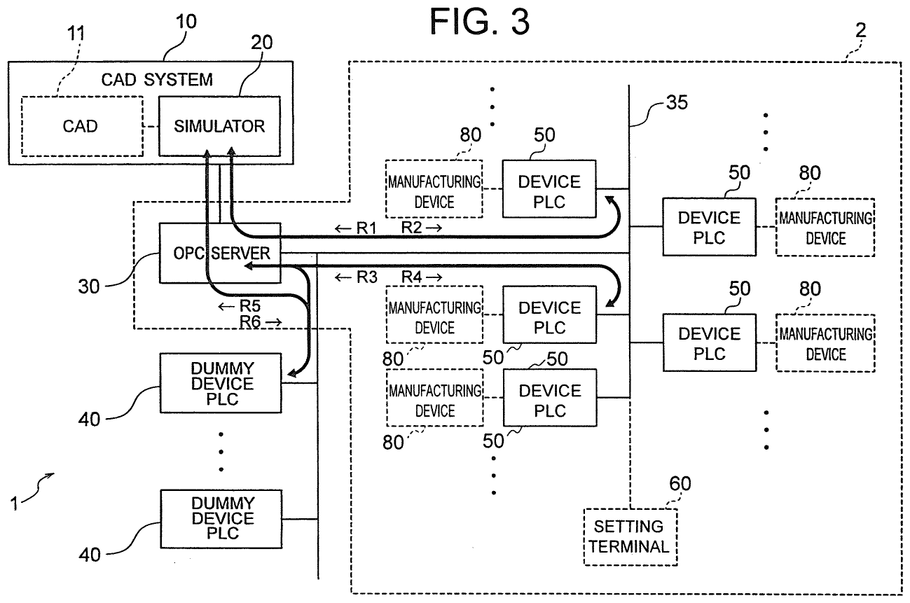

Next, another embodiment of the technology according to the present disclosure is described using FIG. 3 to FIG. 10.

In this embodiment, a control verification system 1 for verifying the control movement of the control device in the production line shown in FIG. 3 is explained, in other words, the control verification system 1 for verifying the control program set in the control device is described.

First, the production line 2 using the control verification system 1 is described using FIG. 3.

The production line 2 shown in FIG. 3 as an example is a production line for producing a product. The production line 2 may be a physical production line configured in real world. Note that, at least part of the production line 2 may be virtually configured using, for example, a computer or so. The production line 2 includes various manufacturing devices 80, a device PLC 50 controlling each manufacturing devices 80, and a setting terminal 60 as a user I/F; and these are connected over the communication network 35.

The manufacturing devices 80 are various machines, tools, devices, systems, units, etc., (these as a whole may be simply referred to as a device) for carrying out processing regarding the production of the product; and for example, the manufacturing devices 80 operate while being controlled by the device PLC 50. Specifically, the manufacturing devices 80 may include a device which transport, process, check, wrap, etc., of various components, semi-products, final products relating to the production of the product. Also, the manufacturing device 80 may include various units (for example, a positioning unit, a serial communication unit, an input-output unit, a camera unit, etc.,) connected to the device PLC 50 so that these can communicate each other. Also, the manufacturing devices 80 may, for example, include various machine tools, robots, rotors, cameras, sensors, image processing devices, etc. Also, the manufacturing devices 80 may include a PLC which control a lower-level manufacturing device (for example, a level configured by other communication networks connected to the communication network 35), or a manufacturing device of other segments.

The device PLC 50 is a control device controlling the manufacturing device 80 (with respect to the device PLC 50, the devices which are the object to be controlled may be referred to as an external device). In the present embodiment, the device PLC 50 is, for example, configured of as a PLC (programable logic controller) executing a control movement of the manufacturing device 80 based on a control program. At least part of the control program executed in the device PLC 50 may, for example, be configured of a ladder program. Note that, the control program is not limited thereto, and it may be configured accordingly using an appropriate program language, program tool, etc. In FIG. 3, the device PLC 50 and the manufacturing device 80 are schematically shown in 1 to 1 relation. However, the configuration may be one device PLC 50 controlling a plurality of manufacturing devices 80. Also, one or more manufacturing devices 80 may be controlled by a plurality of device PLCs 50.

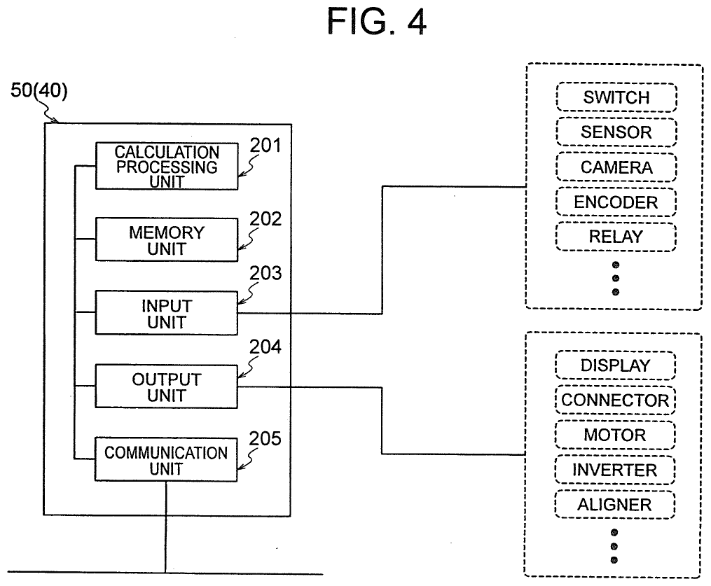

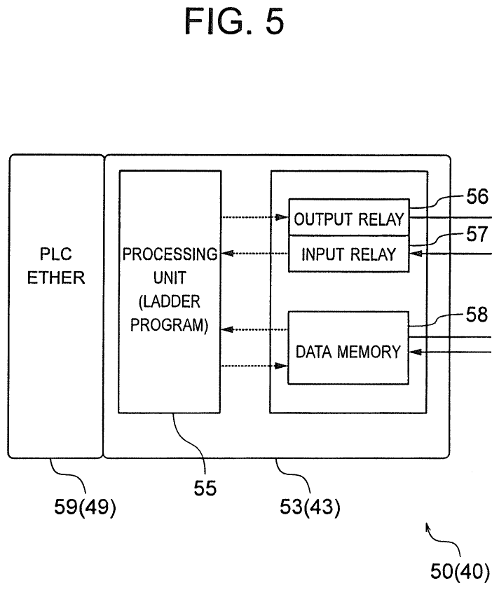

A configuration of PLC used as the device PLC 50 is shown in FIG. 4 and FIG. 5. FIG. 4 is a block diagram showing a functional configuration of PLC used as the device PLC 50. In the case of the specific example shown in FIG. 4, the device PLC 50 includes a calculation processing unit 201, a memory unit 202, an input unit 203, an output unit 204, and a communication unit 205 as functional configuration elements. At least part of these configuration elements may be connected so that these can be communicate with each other.

The calculation processing unit 201 is, for example, configured of a circuit element such as a microprocessor, ASIC (Application Specific Integrated Circuit), etc., and it is configured so as to execute various programs (such as a ladder program).

The memory unit 202 is a memory device capable of memorizing data etc. For example, at least part of the memory unit 202 may be configured of a volatile memory device (for example, a semiconductor device such as DRAM (Dynamic Random Access memory)); at least part of the memory unit 202 may be configured of a non-volatile memory device (for example, a semiconductor memory device such as a flash memory, SSD (Solid State Drive), a magnetic memory device such as HDD (Hard Disk Drive), or an optical memory device such as CD-ROM); or the memory unit 202 may be configured of combination of these.

For example, the memory unit 202 can memorize a program executed in the calculation processing unit 201; a data and setting information used in the input unit 203, the output unit 204, and the communication unit 205; and the setting information of the device PLC itself, etc. In some cases, the memory unit 202 is configured to provide an input-output allocation (I/O mapping) area where the program executed in the device PLC 50 inputs or outputs data (signals) between various units (for example, the manufacturing device 80 is included) connected to the device PLC 50. In this case, the program executed in the device PLC 50 writes the data to the input-output allocation area, and thereby, provides the data (signals) to the manufacturing device 80 mapped in the input-output allocation area.

Also, the program executed in the device PLC 50 reads the data from the input-output allocation area, and thereby, the data (signals) provided from the manufacturing device 80 mapped in the input-output allocation area can be obtained. Note that, sending or receiving the actual data (signals) between the manufacturing device 80 may be executed via the input unit 203 and the output unit 204 which are described later.

The input unit 203 is, for example, configured so as to receive the signals or data provided from the manufacturing device 80 connected to the device PLC 50 in communicable manner. The input unit 203, for example, may be configured as a physical input port (for example, a connection point, a relay, etc.), or may be configured as a theoretical input port (for example, a theoretical channel input, an internal relay, other specialized relay, etc.).

The output unit 204 is configured so as to provide signals and data to the manufacturing device 80 connected to the device PLC 50 in a communicable manner. The input unit 203 may, for example, be configured as a physical output port (for example, a connection point, a relay, etc.) or may be configured as a theoretical output port (for example, a theoretical channel output, an internal relay, other specialized relay, etc.).

The communication unit 205 is configured so as to execute sending and receiving of data between the control communication network (for example, field network). For example, the communication unit 205 may be configured by combining a circuit element used for communication control and a device used for processing of signals in the physical communication layer. The communication unit 205 may send or receive the data used in the calculation processing unit 201, the memory unit 202, the input unit 203, and the output unit 204 via the control communication network.

As the device PLC 50 which satisfies the above-mentioned configuration, for example, a PLC available from manufacturers and venders of common industrial machines now days may be used.

A specific configuration example of the device PLC 50 described in above is further described using FIG. 5. For the sake of explanation, the device PLC 50 shown in FIG. 5 includes a processing unit 55 as an example of the calculation processing unit 201, an input relay 57 as an example of the input unit 203, an output relay 56 as an example of the output unit 204, a data memory 57 as an example of at least part of the memory unit 202, and a PLC Ether 59 as an example of the communication unit 205. In the case of the specific example shown in FIG. 5, the device PLC 50 includes a device PLC-CPU part 53, and the device PLC-CPU part 53 is configured to include the processing unit 55, the output relay 56, the input relay 57, and the data memory 58. Note that, the device PLC 50 is not limited to this, and may include other elements.

The processing unit 55 moves based on the memorized ladder program (control program). The processing unit 55, for example, controls the manufacturing device 80 by sending and receiving the signals (data) between the manufacturing device 80 via the output relay 56, the input relay 57, and the data memory 58. Note that, other than the output relay 56, the input relay 57, and the data memory 58, the processing unit 55 may send and receive the signals (data) between the manufacturing device 80 via an extended memory, other input-output ports, etc. A transfer method and device used for transferring the signals between the manufacturing device 80 and the processing units 55 may be selected accordingly, for example, depending on specifications and standards of the device PLC 50 and the manufacturing device 80. In below, for the sake of explanation, a specific example is described in which the device PLC 50 and the manufacturing device 80 transfer the signals (data) using the output relay 56, the input relay 57, and the data memory 58; however, the technology according to the present disclosure is not limited to this.

The output relay 56 is an element where data is set when it is output from the device PLC 50 to an external machine. The output relay 56 may be achieved, for example, as a circuit element which is set “ON” when the data is output to the external machine. The output relay 56 is not limited to this, and the output relay may be achieved as a theoretical element (for example, an element mapped as an output area in the internal relay, the channel output, and other I/O mapping areas) where the data is set when it is output to the external machine.

The input relay 57 is an element where data is set when data is input from the external device to the device PLC 50. The input relay 57 may, for example, be achieved as a circuit element which is set “ON” when the data is input from the external device. The input relay 57 is not limited to this, and it may also be achieved as a theoretical element (for example, an element mapped as an input area in an internal relay, a channel input, other I/O mapping areas) where the data is set when it is input to the external device.

The data memory 58 is a memory area used for input and output of data between the device PLC 50 and the external device. The data memory 58 is, for example, used for input and output of data between the device PLC 50 and the external device when the output relay 56 or the input relay 57 is “ON”. Also, the data memory 58 is, for example, used when executing input and output of data between the device PLC 50 and the external machine at a certain timing. The data memory 58 may, for example, be a memory area where I/O mapping area is set among the memory unit 202 described in above. The data memory 58 may, for example, be achieved as a memory space configured in a physical or theoretical memory device. Note that, other than input and output of data between the external machine, the data memory 58 may, for example, be used for various purposes in the device PLC 50 (such as, for saving various settings and conditions, for a data storage of various processing and calculation, etc.).

Ether I/F 59 is an interface for connecting the device PLC 50 to the communication network 35. The communication network 35 will be described in detail later.

Note that, in the present embodiment, PLC is shown as an example of a control device controlling the manufacturing device 80. It may also be a control device other than PLC such as Robot Controller (RC), Computer Numerical Controller (CNC), FA Controller configured of generally used personal computers (PC), etc. Depending on the type of the manufacturing device 80, suitable and appropriate controller or computer (hardware, control program) for controlling the manufacturing device 80 may be used.

In the production line 2 shown in FIG. 3, the device PLC 50 and the manufacturing device 80 are connected by appropriate communication networks respectively. Specifically, the connection between the device PLC 50 and the manufacturing device 80 is established by the communication network capable of sending and receiving the above-mentioned signals via the output relay 56, the input relay 57, and the data memory 58 of the device PLC 50. In the present embodiment, the device PLC 50 and the manufacturing device 80 are connected via another field network. Note that, the communication network connecting the device PLC 50 and the manufacturing device 80 may be the network of a different segment from the communication network 35 which is a backbone network of the production line 2. Note that, a part of the device PLC 50 and the manufacturing device 80 may be connected by a communication means different from the field network (for example, a serial communication means etc.).

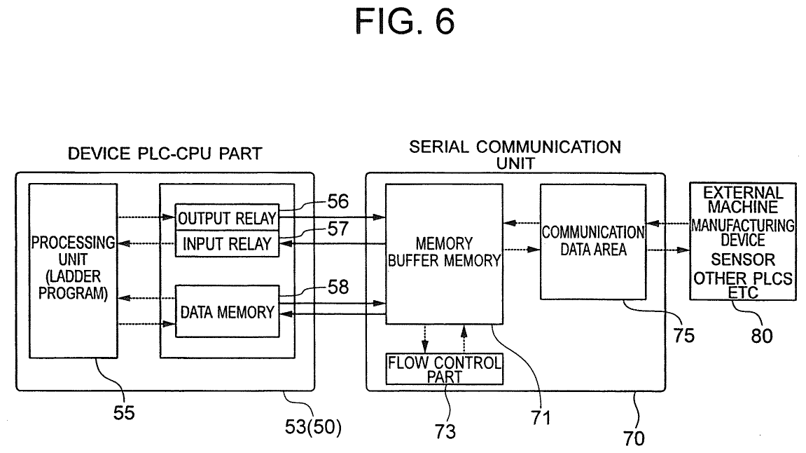

Some of the manufacturing devices 80 are directly connected to the device PLC 50 via the input-output I/F and field network equipped to the manufacturing devices 80. Further, in some cases, considering a compatibility (including a data format, a signal format, timing, delay, rating, etc.), some of the manufacturing devices 80 are connected to the device PLCs 50 via some kind of I/F, or connected to the field network to which the device PLCs 50 are connected. For example, in the connection example shown in FIG. 6, the manufacturing device 80 is connected to the field network via the serial communication network 70, and connected to the device PLC 50 so that the signal (data) can be transferred.

The serial communication unit 70 includes a buffer memory 71 for carrying out a serial data conversion, a flow control part 73 controlling the flow of data, and a communication data area 75 for carrying out input and output of data to the manufacturing device 80. The communication data area 75 sends and receives data between the manufacturing device 80 in an arbitrary data transfer method such as memory sharing, I/O instruction, bus transfer, DMA transfer, etc.

A schematic representation of sending and receiving (transferring) of the signals (data) between the device PLC 50 and the manufacturing device 80 connected as described in above would be summarized in a process as described in below.

In the case that the device PLC 50 outputs signals (data) to the manufacturing device 80, the control program (ladder program) of the device PLC 50 writes to the output relay 56 of the device PLC 50 (that is, sets “ON”), and the manufacturing device 80 monitoring this reads the data from the data memory 58 of the device PLC 50. In the case that the device PLC 50 and the manufacturing device 80 are connected to the field network, data of the data memory 58 of the device PLC 50 may be provided to the manufacturing device 80 using the system (for example, a shared memory, a message communication, etc.) provided from the field network. Also, in the case that the signals are input to the device PLC 50 from the manufacturing device 80, the manufacturing device 80 writes to the input relay 57 of the device PLC 50 (sets “ON”), and the device PLC 50 monitoring this reads the data from the data memory 58. In the case that the device PLC 50 and the manufacturing device 80 are connected by the field network, the data provided from the manufacturing device 80 may be written to the data memory 58 of the device PLC 50 using the system (for example, a shared memory, a message communication, etc.) provided from the field network.

Note that, in the case that special units such as the serial communication unit, etc., mentioned in above exist (for example, as other manufacturing device 80, etc.) between the device PLC 50 and the manufacturing device 80, the above-mentioned process is executed via the special units. For example, in the case that the device PLC 50 outputs the signals (data) to the manufacturing device 80, the control program (ladder program) of the device PLC 50 writes to the output relay 56 of the device PLC 50 (sets “ON”), and the serial communication unit monitoring this reads the data from the data memory 58 of the device PLC 50, then provides to the manufacturing device 80.

Also, in the case that the signals (data) are input to the device PLC 50 from the manufacturing device 80, the serial communication unit receiving the data (signals) from the manufacturing device 80 writes to the input relay 57 of the device PLC 50 (sets “ON”), and the device PLC 50 monitoring this reads the data from the data memory 58. Regarding special units different from the serial communication unit, roughly the same process may be carried out.

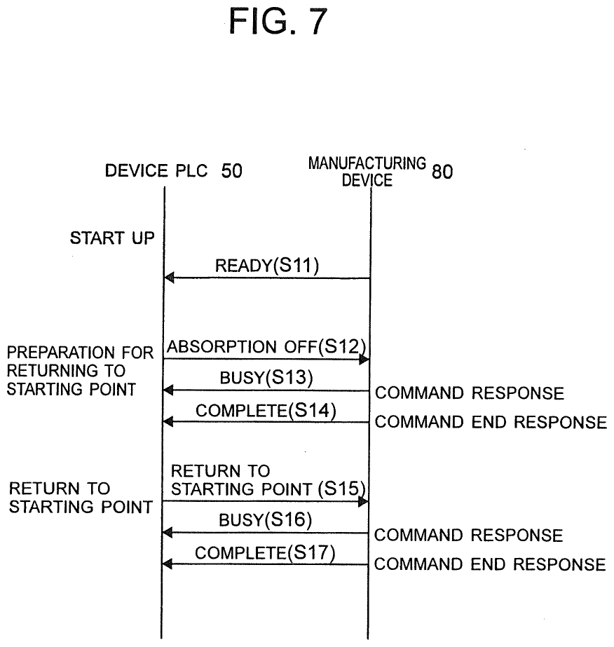

An example of the device PLC 50 actually controlling the manufacturing device 80 by sending and receiving such signals (data) is described using FIG. 7. This example describes the movement controlling the returning of the manufacturing device 80 to the starting point after startup of the manufacturing device 80 such as aligner etc., which carries out processing under a predetermined coordinate system.

Once the manufacturing device 80 (and the device PLC 50) is started and ready to operate, the manufacturing device 80 sends a “Ready” signal to the device PLC 50 (Signal S11). The device PLC 50, which has received this signal, instructs a release of an absorption system (sends absorption “OFF”' instruction) as a preparation for the aligner to return the starting point (Signal S12). The manufacturing device 80, which has received this signal, sets a “Busy” signal to “Busy” as a command reception response and notifies the device PLC 50 (Signal S13). Then, once absorption “OFF” is confirmed via a sensor system in the manufacturing device 80, a response of absorption “OFF” complete (command end response) is returned to the device PLC 50 (Signal S14).

The device PLC 50, which has received Signal S14 of the command end response (absorption “OFF” complete) instructs the manufacturing device 80 to return to the starting point as an initial operation of the next step (Signal S15). The manufacturing device 80, which has received this signal, sets the “Busy” signal to “Busy” as a command reception response (Signal S16). Then, once the return to the starting point is confirmed via a sensor system in the manufacturing device 80, a response regarding the starting point return complete (command end response) is returned to the device PLC 50 (Signal S17).

By sending and receiving these signals between the device PLC 50 and the manufacturing device 80 via the above-mentioned output relay 56, the input relay 57, and the data memory 58, a control of the initial setting shown in FIG. 7 is executed. Note that, sending and receiving of the data explained using FIG. 7 is just an example. In the case that other relay circuits, a trigger method or a data transfer method is defined in the field network connecting the device PLC 50 and the manufacturing device 80, these methods may be used for control.

The setting terminal 60 is a terminal device which functions as a user I/F of the control verification system 1 described later and the production line 2. Administrators of the production line 2 can, for example, operate, set, input data, or monitor condition, etc., of the OPC server 30, the dummy device PLC 40, and the device PLC 50 via the setting terminal 60. Also, the administrators of the production line 2 can load the control program (ladder program) to the device PLC 50, and load the program to the dummy device PLC 40 so as to move as the dummy device. These functions, for example, may be achieved using the CAD system 10 connected to the production line 2 via OPC server 30. Further, the setting terminal 60 is a terminal, for example, connected in a communicable manner to a production site where the production line 2 is configured, and the setting terminal enables to directly monitor, administer, etc., the machines configuring the production line 2.

The communication network 35 is a backbone network of the production line 2 or the control verification system 1. The plurality of device PLCs 50 and the setting terminal 60 configuring the production line 2, the dummy device PLC 40 configuring the later described control verification system 1, and the CAD system 10 are connected in a communicable manner via the communication network 35.

The communication network 35 is, for example, configured by a field network capable of transporting a communication data compliant with OPC (OLE for Process Control). The field network is typically a communication network capable of connecting various industrial machines, control devices, information processing devices (such as computers, etc.) with each other. The field network may, for example, be configured as a communication network compliant with protocols (for example, IEC 61158 etc.) which have been standardized. Specific examples of the field network may include, Ether CAT, Ethernet/IP, FL-net, PROFINET, etc., however, it is not limited to these.

An OPC server 30 is connected to the communication network (field network) 35. The OPC server 30 is a device capable of sending and receiving data, commands, etc., to/from other devices (for example, the device PLCs 50, the dummy device PLCs 40, the setting terminals 60, the manufacturing devices 80, etc.) connected to the field network. The CAD system 10 is connected to the communication network 35 via the OPC server 30.

The device PLC 50, the setting terminal 60, and the dummy device PLC 40 are, for example, connected to the communication network 35 as an OPC client. The OPC client can, for example, receive signals, data, commands, etc., from the OPC server via the field network.

Each device connected to the communication network 35 can send and receive the commands and can data link (data transfer) between other devices in compliance with the specifications of the field network. As an example, each device connected to the communication network 35, for example, can read the data from and write the data to the memory space including specific areas such as input areas of other devices (for example, an input port, an input channel, an input relay, etc.), output areas (for example, an output port, an output channel, an output relay, etc.), memory areas (for example, a data memory etc.).

Also, each of the specific areas may be the above-mentioned I/O mapping area. A specific configuring method of processing for achieving the above specific areas may be selected depending on the specifications of the field network. For example, each device connected to the field network can send and receive the message including an address of the device to send the message, a sender address, a field which stores commands, data, etc., and thereby, reading and writing of the data between each specific area may be executed.

As one embodiment, a field network is known which can directly input and output data (data exchange) between the connected devices to part of the memory space including the specific areas (for example, the input area, the output area, the memory area, etc.). In this case, each device, for example, interprets the field included in the received message and executes writing to the specific area, thereby, reading and writing of data is executed. In this case, it is thought that due to this field network a virtually shared memory space, so to speak, where each device can share the specific area with other device is configured.

In the case that the communication network 35 is configured of such field network, the device connected to the communication network 35 can send and receive various commands and data transparently between the other devices. For example, by setting the output relay 56, the input relay 57, and the data memory 58 of the device PLC 50 to a specific area, other devices connected to the field network (for example, other device PLCs 50, the later described dummy device 40, the OPC server 30, etc.) can access this specific area by sending and receiving the message.

Also, the CAD system 10 (simulator 20) can access to the output relay 56, the input relay 57, and the data memory 58 of another device PLC 50 (or the dummy device PLC 40) connected to the communication network 35 by sending and receiving the message via the OPC server. Also, the CAD system 10 (simulator 20) can provide commands and data included in the message received via the OPC server 30 from another device PLCs 50 (or the dummy device PLC 40) connected to the communication network 35 to a model of the virtual manufacturing device 80 configured by the simulator 20. In this case, the OPC server 30 may be configured so as to provide the shared specific area with another device PLC 50 (or the dummy device PLC 40) connected to the communication network 35.

Note that, the field network is a known technology in modern time, thus, detail description of sending and receiving of a specific data will be omitted from explaining.

In the production line 2, each device PLC 50 is connected to the communication network 35. In this case, for example, one device PLC 50 can directly communicate (data transfer) in real-time with another device PLC 50. As a result, the information used for controlling the object to be controlled is transferred at an appropriate timing. Thereby, for example, a status tracking based on the data from sensors and measuring devices, tracking the operation status of each manufacturing device 80, and controlling of various manufacturing devices 80 based on these can be executed at an appropriate timing. These processing in the production line 2 can be executed roughly in real-time depending on situations.

Next, following explains the control verification system 1 for verifying the control program used for controlling the object (manufacturing device 80) using the device PLC 50 to the production line 2 which satisfies the above-mentioned configuration, and thereby, verifying the control movement of the manufacturing device 80 using the device PLC 50.

The control verification system 1 virtually replicates the operated condition of the manufacturing device 80 (the object to be controlled) on the computer network; and in such virtual environment (digital twin environment), the controlled condition of the manufacturing device 80 in the device PLC 50 (control device) is verified. The control verification system 1 has a configuration that the simulator 20 and the dummy device PLC 40 are included in the above-mentioned production line 2.

The simulator 20 simulates the movement of the manufacturing device 80 (the object to be controlled). When the control verification system 1 is operating in a simulation mode, for the manufacturing device 80 which can be simulated by the simulator 20, the simulator 20 operates instead of the manufacturing device 80 to simulate the movement of the manufacturing device 80. More specifically, for example, the movement of the manufacturing device 80 is simulated by a virtual manufacturing device configured by the simulator 20.

The simulator 20 is linked with a CAD tool 11. The simulator 20 simulates the movement of the manufacturing device 80 based on the design data or other data of the manufacturing device 80 included in the CAD tool 11 which can be used for simulation of the movement of the manufacturing device 80. In the present embodiment, the simulator 20 is installed as a CAD system 10 on the same computer to which the CAD tool 11 is installed. Note that, the simulator 20 may be configured on its own. Also, the simulator 20 may be integrated with the CAD tool 11, or it may also be provided as a part of the CAD tool 11.

The data which can be used for the movement simulation of the manufacturing device 80 may, for example, include the CAD data of the manufacturing device configured in a virtual space based on the design information and the movement specifications of the manufacturing device 80, an input-output specification data of the manufacturing device 80, etc. Specifically, the data for the simulation of the movement of the manufacturing device 80 may be any selected from, data made by the CAD tool 11, the data received from the manufacturer of the manufacturing device 80, or data received from a third party. In regards with standard and widely-used components, products, machines, apparatus, devices, in many cases, design data, CAD data, or movement simulation data are available. The simulator 20 has a system which can simulate using such data. For the manufacturing device 80 which a sufficient amount of data to be used for the movement simulation is not available, in some cases, the simulation may not be possible for the simulator 20.

The simulator 20 is connected to the communication network via the OPC server 30. The dummy device PLC 40 and the device PLC 50 are also connected to the communication network 35, and the simulator 20 can send and receive the signals (data) to the dummy device PLC 40 and the device PLC 50 via the communication network 35.

As a typical embodiment, the simulator 20 performs the movement simulation of the manufacturing device 80, which is the object, based on the signals (input signals) provided from the device PLC 50, and the output signals based on the simulation result are provided to the device PLC 50 which controls the manufacturing device 80, which is the object. Here, the simulator 20 sends and receives the signals (data) to/from the output relay 56, the input relay 57, and the data memory 58 of the device PLC 50 which controls the manufacturing device 80, which is the object, via the OPC server 30 and the communication network 35. Note that, the input signals referred in here are signals (input signals) provided directly to the simulator 20 from the device PLC 50 without going through the later described dummy device PLC 40.

Further, the simulator 20 can send and receive the signals (data) to/from the dummy device PLC 40. Thus, in some cases, the simulator 20 may carry out the simulation based on the signals (input signals) provided from the dummy device PLC 40. Also, the output signals of the simulation result can be provided to the dummy device PLC 40. Note that, the signals (data) output to the dummy device PLC 40 are not the final simulation result provided to the device PLC 50, and it may be signals (data) for the further processing in the dummy device PLC 40, such as the signals (data) in the middle of simulation process.

As such, in the simulator 20, receiving of the input signals and sending of the output signals can be selectively done to the device PLC 50 and the dummy device PLC 40, respectively.

A receiver of the input signals and a sender of the output signals can be selected by changing the area (address) where data is written in the program of the simulator 20 or in the program of the dummy device PLC 40. That is, the simulator 20, the device PLC 50, and the dummy device PLC 40 can select the receiver of the input signals and the sender of the output signals depending on the definitions of the system environment in the field network with respect to an address space of the simulator 20 (execution environment of each simulation program via the OPC server 30) and each dummy device PLC 40.

The dummy device PLC 40 generates dummy signals emulating at least part of the operation result of the manufacturing device 80 when the control verification system 1 is operating in a simulation mode. In other words, the dummy device PLC 40 is configured to generate the dummy signals emulating at least part of the operation result of the manufacturing device 80 in place of simulator 20 or the manufacturing device 80.

As one example, following considers the case where the manufacturing device 80 which the simulator 20 cannot simulate at least part of the movement of the manufacturing device 80. In such case, the simulator 20 cannot completely replace the movement of the manufacturing device 80. In such situation, the dummy device 40 generates the signals as the output signals (dummy signals) which are the same as the signal output as the operation result when the manufacturing device 80 actually operates while being controlled by the device PLC 50. That is, the dummy device PLC 40 generates, in place of the simulator 20 (more specifically, in place of the manufacturing device 80 which cannot be simulated by the simulator 20), the output signals (dummy signals) corresponding to the operation result of the manufacturing device 80. Thereby, by using the dummy device PLC 40 (or the combination of the dummy device PLC 40 and the simulator 20), the manufacturing device 80, which the part of the movement cannot be simulated by the simulator 20, can be virtually operated in a simulation mode. As a result, processing of the device PLC 50 controlling the manufacturing device 80 (for example, processing of ladder programs executed by the device PLC 50) can be verified in a simulation mode.

The dummy device PLC 40 may be provided for the manufacturing device 80 which parts of the movement cannot be simulated by the simulator 20. The dummy device PLC 40 may be provided for the device PLC 50 controlling the manufacturing device 80 which part of the movement cannot be simulated by the simulator 20.

The dummy device PLC 40 is, for example, configured of a PLC (see FIG. 5) having the same configuration as the device PLC 50. In this case, the dummy device PLC 40 operates based on the program made to generate the output signals (dummy signals) which are the same as the result of the corresponding manufacturing device 80 operated by being controlled by the device PLC 50. As a result, the dummy device PLC 40, when it operates, generates the output signals which are the same as the operated result of the manufacturing device 80 (the object to be controlled). In the present embodiment, the dummy device PLC 40 operates, for example, based on the program made of a ladder program.

Note that, the output signals (dummy signals) generated by the dummy device PLC 40 do not necessarily have to be the entire signals (data) transferred to the device PLC 50 from the manufacturing device 80, as the result of the corresponding manufacturing device 80 operated while being controlled by the device PLC 50. As long as the verification of the controlled movement in the control verification system 1 can be thoroughly done by generating output signals of at least part of the signals output to the device PLC 50 as a result of the operation of the manufacturing device 80 and then by providing the generated output signals to the device PLC 50, only the necessary part of the signals may be provided to the device PLC 50.

“The output signals which are the same as the result of the operation of the corresponding manufacturing device 80” generated by the dummy device PLC 40 may include the signals representing the operated condition of the manufacturing device 80 (the object to be controlled).

In the case that the manufacturing device 80 is a machine tools, the above-mentioned “the signals representing the operated condition” may, for example, include signals relating to a processing treatment using a machine tools (for example, information relating to processing steps, information relating to a processing result). In the case that the manufacturing device 80 is a motor, “the signals representing the operated condition” may, for example, include signals relating to the motor (for example, a rotational speed, torque, a rotation position, a power consumption, etc.). In the case that the production device 80 is a robot, “the signals representing the operated condition” may, for example, include signals relating to the robot (for example, an operated condition, a position of operating part, etc.). In the case that the manufacturing device 80 is a sensor, “the signals representing the operated condition” may, for example, include signals relating to the sensor (for example, a sensor output). In the case that the manufacturing device 80 is an image processing device, “the signals representing the operated condition” may, for example, include signals showing the result of image processing. “The signals representing the operated condition” are not limited to above, and it may be set accordingly based on the configuration, spec, treatment, etc., of the manufacturing device 80.

Also, “output signals” may, for example, include signals showing a load which changes over time due to a predetermined pressure, signals including a predetermined image, and signals representing a response of the manufacturing device 80 provided to the device PLC 50 (the control device) from the manufacturing device 80 (the object to be controlled). Also, “output signals” may be signals (data) which have adjusted the data of the above-mentioned context so that it can be input to the corresponding device PLC 50 from the point of a data format, a signal format, timing/delay, rating, etc. Note that, adjustment of timing/delay includes generating the signals at a certain timing which is different from the timing at which the input signals were received. Note that, the above-mentioned signals (signals relating to the object to be controlled) generated in the dummy device PLC 40 are not limited to these mentioned in above. The signals may include signals relating to a sensor configuring the manufacturing device (the object to be controlled) 80, signals relating to the movement of robot, signals relating to the movement of machine tools, etc. Also, “output signals” may be data based on the input signals, data prepared in advance, data obtained by performing the movement simulation of the manufacturing device 80 using the dummy device PLC 40, etc.

Also, the dummy device may generate the output signals and output at a certain timing different from the timing at which the input signal was received.

The dummy device PLC 40 is connected to the communication network 35. The simulator 20 is connected to the communication network 35 via the device PLC 50 and the OPC server 30. The dummy device PLC 40, the device PLC 50, and the simulator 20 can send and receive the signals (data) over the communication network 35.

The dummy device PLC 40, as a typical example, generates the output signals which are the same as the result of the operation of the manufacturing device 80 as the object to be controlled based on the signals (input signals) provided from the device PLC 50, and then the output signals are provided to the device PLC 50 of the manufacturing device 80 of the object. Here, the signals (data) are sent and received between the dummy device PLC 40 and the device PLC 50. Specifically speaking, the signals (data) are sent and received between the output relay 56, input relay 57, and data memory 58 of the dummy device PLC 40 and the output relay 56, input relay 57, and data memory 58 of the manufacturing device 80 as the object via the communication network 35.

The dummy device PLC 40 can send and receive the signals (data) between the simulator 20, hence, in some cases, the dummy device PLC 40 may generate the output signals based on the signals (input signals) received from the simulator 20. Also, the dummy device PLC 40 can provide the generated output signals to the simulator 20, or to another device PLC 50 different from the device PLC 50 which has received the input signal.

That is, the dummy device PLC 40 can selectively receive the input signals and provide the output signals to any one of the corresponding device PLC 50, another device PLC 50, and the simulator 20.

The signals (data) output by the dummy device PLC 40 to the simulator 20 are not limited to the final output signals which are the same as the result of the operation of the manufacturing device 80 as the object.

Also, the signals (data) output from the dummy device PLC 40 to the simulator 20 may be signals used for simulating the movement of the manufacturing device 80 by the simulator 20. Although the simulator 20, for example, includes design data used for the simulation of the manufacturing device 80, there may be cases that the simulation cannot be done since the data format of the signals (data) received from the device PLC 50 are not compatible. In such cases, by generating data in a format which is compatible with the dummy device PLC 40 and providing such data to the simulator 20, simulation can be carried out by the simulator 20. The dummy device PLC 40 may be used for such purposes.

For example, the receiver of the input signals and the sender of the output signals can be selected by changing an area (address) where the data is written in the program of the simulator 20 or the program of the dummy device PLC 40. That is, depending on the definition of the system environment in the field network with respect to the address space of the simulator 20 and each dummy device PLC 40, the simulator 20, the device PLC 50, and the dummy device PLC 40 can select the receiver of the input signals and the sender of the output signals.

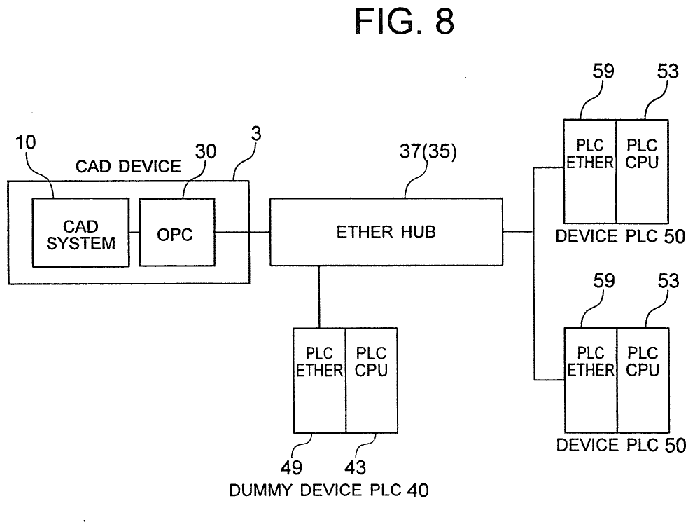

In below, the actual implementation of the control verification system 1 including such configuration is explained by referring to FIG. 8. In FIG. 8, the manufacturing device 80 is not shown, and the device PLC 50 controlling the manufacturing device 80 and the implementation embodiment of the control verification system 1 verifying the operated condition of the device PLC 50 are shown.

As shown in FIG. 8, the dummy device PLC 40 includes a CPU part 43 and an Etherl/F 49, and the device PLC 50 includes a CPU part 53 and an Etherl/F 59; and the dummy device PLC 40 and the device PLC 50 are connected to the communication network 35 via the Etherl/F 49 and 59. The dummy device PLC 40 and the device PLC 50 can execute writing and reading of the data to/from the memory space including the above-mentioned specific area via the communication network 35.

In the case that the configuration of the production line 2 or the control verification system 1 is compact, a switching hub (Ether HUB) 37 may be used as the communication network 35 as it is shown in FIG. 8. Also, a plurality of device PLCs 50 and dummy device PLCs 40 may, for example, be placed into a case all together, and these can be configured as a so-called of a build-in type.

Also, the CAD tool 11, the simulator 20, and the OPC server 30 can be configured as software, and for example, as shown in FIG. 8, these may be equipped to one computer (CAD device) 3. In this case, the memory device configuring the computer 3 may provide a memory space including the above-mentioned specific area.

Although, there is no particular limited to the implementation of the control verification system 1, and for example, by taking the configuration shown in FIG. 8, a control verification system 1 which has overall compact configuration can be achieved.

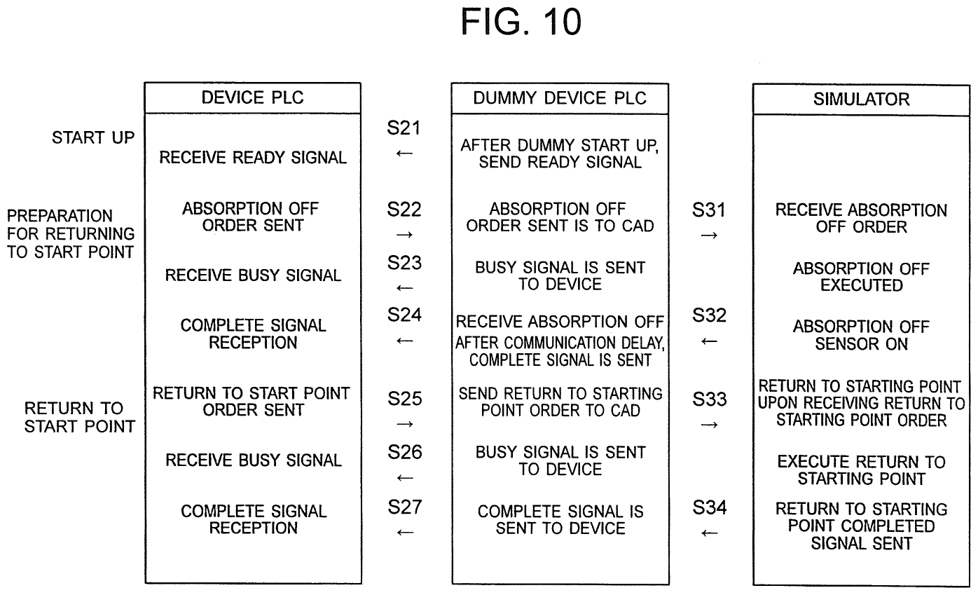

Next, the movement of the control verification system 1 is described using FIG. 3 and FIG. 10.

First, the case of verifying the control condition of the manufacturing device 80 which can be simulated by the simulator 20 is described using FIG. 3.

In this case, the device PLC 50 writes the desired order to the output relay 56, the input relay 57, and the data memory 58 of the device PLC 50 as similar to the case when actually instructing the manufacturing device 80. This order can be simulated by the simulator 20, thus, the order is provided to the simulator 20 via the OPC server 30 (Route R1). The simulator 20 executes the simulation based on this order. Then, the simulation result is sent to the device PLC 50 from the simulator 20 via the OPC server 30 (Route R2). The device PLC 50 which has received the simulation result proceeds to next control movement based on the control program (ladder program) set in the device PLC 50. As such, using the simulation by the simulator 20, the control movement of the device PLC 50 is executed and verified in the virtual environment without using the manufacturing device 80.

Next, the movement of the control verification system 1 is described using FIG. 3 and FIG. 10 which is the case that the simulation can be done by the simulator 20, but the order from the device PLC 50 cannot be directly sent to the simulator 20. As a specific example, the movement of the control verification system 1 is described which is for verifying the control program regarding the movement controlling the return to the starting point after the startup of the manufacturing device such as an aligner. Note that, FIG. 10 shows the flow of signals during the verification process corresponding to the process relating to the production line 2 shown in FIG. 7.

First, once the dummy device PLC 40 has started and the verification process is ready to begin, the dummy device PLC 40 sends “Ready” signal to the device PLC 50 (Signal S21, Route R4). That is, the data which corresponds to the Ready signal is written to the predetermined address of the device PCL 50.

The device PLC 50 which accepted (received) the signals from the dummy device PLC 40 writes the release order of the absorption system (absorption OFF order) of the manufacturing device 80 to the predetermined address as a preparation of the aligner for returning to the starting point. Instead of the actual production device 80, the corresponding dummy device PLC 40 accepts this order (Signal S22, Route R3).

The dummy device PLC 40 which has received the order sends the instruction to the simulator 20 (Signal S31, Route R5). Here, the dummy device PLC 40 sends the absorption OFF order (S22) from the device PLC 50 to the simulator 20 (S31). As an example, in the case that the absorption OFF signal from the device PLC 50 is in a string format, the dummy device PLC 40 converts the data into a binary format so that the simulator 20 can understand. Also, the dummy PLC 40 may, for example, send the absorption OFF order to the simulator 20 at an appropriate timing (for example, a timing delayed for predetermined waiting time, a communication timing defined in the field network, etc.). That is, the dummy device PLC 40 can send the order to the simulator 20 at a timing different from the timing at which the device PLC 50 has received the absorption OFF order.

Also, the dummy device PLC 40 sets the Busy signal as the command reception response to “Busy” and notifies the device PLC 50 (Signal S23, Route R4). Without receiving the Busy signal from the simulator 20, the dummy device PLC 40 sends the Busy signal to the device PLC 40 due to the execution of the program set in the dummy device PLC 40. Also, here, the dummy device PLC 40 converts, for example, the binary form signals received from the simulator 20 into a string data format so that the device PLC 50 can understand. The signals are sent to the device PLC 50 using a predetermined time delay or the communication timing set by the field network.

Then, when the simulation result of the manufacturing device 80 turns to absorption OFF in the simulation by the simulator 20, a response of the absorption OFF complete (command end response) is sent to the dummy device PLC 40 from the simulator 20 (Signal S32, Route R6). The dummy device PLC 40 carries out the timing adjustment, the signal format conversion, etc., to the signals from the simulator 20, and then sends the signals to the PLC device 50 (Signal S24, Route R4).

The device PLC 50, upon receiving the command end response (absorption OFF completed), which is Signal S24, instructs the manufacturing device 80 to return to the starting point as the next initial movement (Signal S25, Route R3).

The dummy device PLC 40 receiving this, instead of the manufacturing device 80, sends the instruction to the simulator 20 (Signal S33, Route R5) and also sets the Busy signal as the command reception response to “Busy” and notifies to the device PLC 50 (Signal S26, Route R4).

Then, when the simulation result of the manufacturing device 80 returns to the starting point in the simulation by the simulator 20, the response of the starting point return completed (command end response) is sent to the dummy device PLC 40 from the simulator 20 (Signal S34, Route R6). The dummy device PLC 40 carries out the timing adjustment, the signal format conversion, etc., to the signals from the simulator 20, and then the signals are sent to the PLC device 50 (Signal S27, Route R4).

As such, the control movement of the device PLC 50 is executed and verified in the virtual environment even in the case that the simulation can be executed by the simulator 20 but the order cannot directly send to the simulator 20 due to the compatibility between the device PLC 50 and the simulator 20.

Next, the movement of the control verification system 1 which the simulator 20 cannot simulate at least part of the manufacturing device 80 is described using FIG. 3.

For example, the case where the device PLC 50 orders to import the image data to the manufacturing device 80 such as an image processing device including an imaging device will be considered. In such case, first, as similar to the case actually instructing the manufacturing device 80, the device PLC 50 writes the image import order to the output relay 56, the input relay 57, and the data memory 58 of the device PLC 50.

Instead of the actual manufacturing device 80, the corresponding dummy device PLC 40 receives this order (Route R3). This type of image data may be generated by simulation. There may be cases that such type of image data cannot be generated by simulation. In below, the case that such type of image data cannot be generated by simulation is described. In this case, the dummy device PLC 40 is programed to return the dummy image data prepared in advance to the device PLC 50. Therefore, the dummy device PLC 40 which has received the order reads the prepared image data, and for example, delays for the length of time needed for image taking or image processing, then it is sent to the device PLC 50 (Route R4).

For the manufacturing device 80 which cannot use the simulation, the control movement of the device PLC 50 is executed and verified in virtual environment.

Other than importing the image data as mentioned in above, as examples of the dummy device PLC 40 notifying the device PLC 50 with the response signal made by the dummy device PLC 40 itself or prepared in advance, followings may be included. That is, processing which only simply replies ACK to the command output from the device PLC 50, processing which replies an appropriate value to the load measurement command from the device PLC 50, etc., can be included.

Other than mentioned in above, as an example of the movement of the control verification system 1, after the dummy device PLC 40 receives data output from the simulator 20, appropriate processing can be done by the dummy device PLC 40, and the data may be output to the simulator 20 without going through the device PLC 50.

Specific examples of such movement may include the movement which is defined to carry out a plurality of movements in one command. For example, such cases may include the case that the device PLC 50 sends an order to the manufacturing device 80, such as one processing treatment order regarding process target items (these may be referred to as a work). In this case, the dummy device PLC 40, which has received this order in place of the manufacturing device 80, emulates the processing movement of the manufacturing device 80, then the instruction of processing treatment is first sent to the simulator 20 regarding process target items.

Next, when the dummy device PLC 40 receives a notification which represents end of one process from the simulator 20, then the dummy device PLC 40 sends an instruction of processing regarding the next process target item. When processing treatment is done to all of the process target items, the dummy device PLC 40 sends a notification of process end to the device PLC 50. During series of these process, the dummy device PLC 40 substantially has no communication with the device PLC 50, and the dummy device PLC 40 can be in a state which only communicates with the simulator 20. The control verification system 1 can move and operate in such embodiment. Note that, such process can be applied by executing series of processing orders in one command to one process target item, and it may also be applied by executing one or more processing orders in one command to each of the plurality of process target items.

Also, in the control device system 1, by actively using the dummy device PLC 40, not only as a substitution of the manufacturing device 80, various verifications of the production line 2 can be carried out.

For example, by moving the simulator 20 while some of the device PLCs 50 have not been placed, it is possible to verify the condition of the specific manufacturing device or at least part of the production line.

As one example of such case, when a specific component is modified, there may be occasion which will need to carry out verifications such as an interference check, vibration analysis, etc., by moving the simulator 20 while some of the device PLCs 50 have not been placed. In such case, the dummy device PLC 40 provides the dummy signals; thereby, the simplified movement condition emulating the unequipped device PLCs 50 can be notified to the simulator 20. Thereby, the control verification system 1 can carry out the above-mentioned verification by operating the simulator 20. That is, appropriate signals (data) can be provided to the simulator 20 by using the dummy device PLC 40 in place of the unequipped device PLCs 50.

As discussed in above, in the control verification system 1, based on the simulation result of the simulator 20 and the output signals generated by the dummy device PLC 40, the device PLC 50 can virtually replicate the condition controlling the manufacturing device 80. As a result, the verification of the control program by the device PLC 50 can be carried out easily.

Particularly, in the control verification system 1, the control movement of the device PLC 50 under virtual environment can be executed, that is, the control program can be executed even in the case that at least part of the simulation cannot be done by the simulator 20, or in the case that the simulation can be executed by the simulator 20 but the order cannot directly send to the simulator 20 due to the compatibility between the device PLC 50 and the simulator 20.

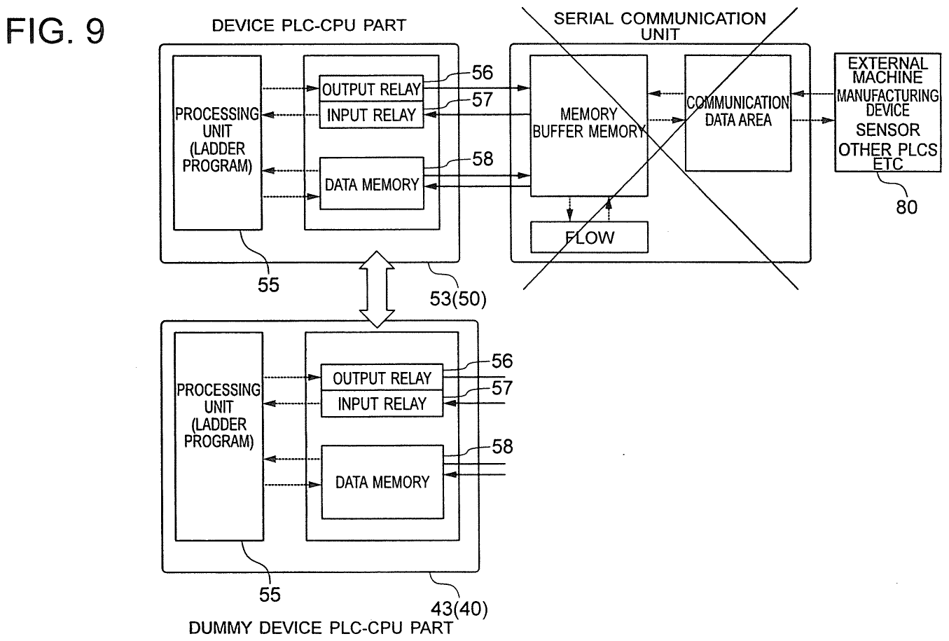

Specifically, for example as shown in FIG. 9, the case simulating the movement of the manufacturing device 80 connected to the device PLC 50 and other manufacturing device 80 via a special I/F unit (for example, a serial communication unit 70) may be considered. As one example, it is possible to use a complicated method which virtually configures the entire manufacturing device 80, and the entire special I/F unit (for example, these virtual models are prepared under simulation environment). However, if such complicated method is employed, it will require a lot of time, man-hour, and cost in order to individually virtualize the various manufacturing devices 80, special I/F unit, etc. Also, in some cases, there may be a manufacturing device 80 or I/F unit which the movements are too complicated to virtualize.

In this case, for example, even when simulation environment by the simulator 20 is available, if the manufacturing device 80 and special I/F unit cannot be virtualized, it is difficult to use the simulation result under the control of the device PLC 50.

The control verification system 1 can directly manipulate (write and read) the area (for example, a theoretical memory space configured of the field network) relating to input and output of the device PLC 50 using the dummy device PLC 40 via the field network. Therefore, even under the condition shown in FIG. 9, the signals (data) can be sent to and received from the device PLC 50 without preparing models virtualizing the serial communication unit 70 itself. As a result, the device PLC 50 and the simulator 20 can be linked via such dummy device PLC 40, thus the control verification system 1 can carry out the verification of the control program to such manufacturing device 80 (or the simulator 20).

In general, when the manufacturing device 80 is a robot, a communication device, an image processing device, a load controlling device, etc., in many cases, it may not be easy to simulate the movement of these using the simulator 20, or to link with the simulation. In the control verification system 1, the dummy device PLC 40 is used, thereby, the manufacturing device 80 can be easily linked to the simulator 20. Thus, in the control verification system 1, the simulation can be easily used for the verification of the control program for the manufacturing device 80.

Also, in the control verification system 1, by using the control verification system 1 to the production line 2 including several manufacturing devices 80 (objects to be controlled) relating to the production of the products, the controlled condition of the plurality of device PLCs 50 controlling the manufacturing devices 80 can be verified, and the operated condition of the production line 2 can be verified.

Note that, the technology according to the present disclosure is not limited to the above-mentioned embodiments, and arbitrary and suitable various modifications are possible.

For example, in the above-mentioned embodiments, the system using the technology according to the present disclosure to the production line for the product production is shown as an example. However, the technology according to the present disclosure is not limited to this, and it can be used for a system including machines, etc., controlled by the control device.

Also, the dummy device PLC 40 and the device PLC 50 are not limited to PLC. Particularly, the dummy device PLC 40 may, for example, be achieved by configuring software which can link with a memory of PLC (device PLC 50) on a generally used computer.

Also, the same function as the dummy device PLC 40 may be achieved via the OPC server 30 by using software which rewrites the memory of PLC (device PLC 50) via the OPC server 30.

Also, a signal (data) transfer method mentioned in PLC (the dummy device PLC 40, the device PLC 50), that is, the data transfer method via the output relay 56, the input relay 57, and the data memory 58 of PLC are not limited to these, and any methods may be used as long as it is a method capable of obtaining the same effects.

### REFERENCE SIGNS LISTS

1 . . . Control verification system
2 . . . Production line
3 . . . CAD device
10 . . . CAD system
   11 . . . CAD tool
   20 . . . Simulator
30 . . . OPC server
35 . . . Communication network
37 . . . Ethernet HUB
40 . . . Dummy device PLC
   43 . . . Dummy device PLC-CPU part
   49 . . . Ether I/F
50 . . . Device PLC
   53 . . . Device PLC-CPU part
      55 . . . Processing part
      56 . . . Output relay
      57 . . . Input relay
      58 . . . Data memory
   59 . . . Ether I/F
60 . . . Setting terminal
70 . . . Serial communication unit
   71 . . . Buffer memory
   73 . . . Flow control part
   75 . . . Communication data area
80 . . . Manufacturing device (external machine)
S11 to S17, S21 to S27, S31 to S34 . . . Transfer signal
R1 to R6 . . . Signal transfer route

1. A verification system, comprising:
a simulator simulating an operated condition of an object to be controlled;
a dummy device, instead of the simulator or a control device, generating a second signal relating to the object based on a first signal to provide the generated second signal to the simulator or the control device, the first signal being provided from the control device capable of controlling the object;
wherein the simulator generates a third signal representing the operated condition of the object simulated based on the second signal provided from the dummy device.

2. The verification system according to claim 1, wherein the dummy device generates the second signal based on the first signal, the second signal representing at least a part of the operated condition of the object unable to be virtually replicated by the simulator, and
the dummy device provides the generated second signal to the simulator or the control device.

3. The verification system according to claim 1, wherein the dummy device generates the second signal based on the first signal, the second signal representing at least a part of the operated condition of the object used for simulating the operated condition of the object by the simulator, and
the dummy device provides the generated second signal to the simulator or the control device.

4. The verification system according to claim 1, wherein the dummy device provides the second signal to the simulator at a certain timing different from a timing at which the dummy device receives the first signal from the control device.

5. The verification system according to claim 1, wherein the simulator generates the third signal based on at least one of the second signal and a fourth signal provided from the control device.

6. The verification system according to claim 1, wherein the dummy device generates a dummy signal as the second signal based on the first signal, the dummy signal emulating an output signal from the object; and
the dummy device provides the generated dummy signal to at least one of the simulator and the control device.

7. The verification system according to claim 6, wherein the dummy signal includes at least one of
a signal representing the operated condition of the object, and
a signal representing a response provided to the control device from the object.

8. The verification system according to claim 1, wherein
the dummy device includes a virtual memory space capable of sharing data over a control communication network by which a signal used for controlling the object can be transported;
the simulator includes a virtual memory space capable of sharing data over the control communication network; and
the simulator and the dummy device write data to the respective virtual memory spaces via the control communication network or read data from the respective virtual memory spaces via the control communication network to communicate the second signal and the third signal.

9. The verification system according to claim 8, wherein
the simulator receives the second signal provided from the dummy device by reading the written data from the virtual memory space via the control communication network; and
the simulator provides the third signal to the dummy device by writing the data to the memory space of the dummy device via the control communication network.

10. The verification system according to claim 8, wherein
the dummy device receives the first signal provided from the control device and the third signal provided from the simulator by reading the written data to the memory space via the control communication network; and
the dummy device provides the second signal to the simulator by writing the data to the virtual memory space of the simulator via the control communication network.

11. The verification system according to claim 8, wherein
the control device includes a memory space capable of sharing data over the control communication network;
the dummy device receives the first signal provided from the control device and the third signal provided from the simulator by reading the data written to the memory space via the control communication network; and the dummy device provides the second signal to the control device by writing the data to the memory space of the control device via the control communication network.

12. The verification system according to claim 8, wherein
the control communication network is a network capable of transporting communication data compliant with OPC (OLE for Process Control);
the dummy device is connected to the control communication network as an OPC client; and
the simulator includes an OPC server and is connected to the control communication device via the OPC server.

13. The verification system according to claim 12, wherein
the dummy device comprises a PLC including a memory device providing the memory space, a computing device capable of executing a process of generating at least the second signal, and a communication device capable of connecting to the control communication network;
the simulator comprises a computer including a memory device providing the virtual memory space and a computing device capable of at least executing an application program capable of schematically replicating the operated condition of the object using a virtual model of the object, and an application program including a function of the OPC server; and
the dummy device connects to the control communication network as the OPC client and the simulator connects to the control communication network as the OPC server by executing the application program including the function of the OPC server.

14. A verification method, comprising:
simulating an operated condition of an object to be controlled using a simulator;
generating a second signal relating to the object using a dummy device instead of a simulator or a control device based on a first signal to provide the generated second signal to the control device or the simulator, the first signal being provided from the control device capable of controlling the object; and
generating a third signal, using the simulator, representing an operated condition of the object simulated based on the second signal provided from the dummy device.
